(19) United States
(12) Patent Application Publication
(10) Pub. No.: US 2016/0369121 A1
(43) Pub. Date: Dec. 22, 2016

(54) NANOCRYSTALINE CELLULOSE AS ABSORBENT AND ENCAPSULATION MATERIAL

(71) Applicant: MELODEA LTD., Rehovot (IL)

(72) Inventor: Shaul LAPIDOT, M.P. Shimshon (IL)

(73) Assignee: MELODEA LTD., Rehovot (IL)

(21) Appl. No.: 15/122,320

(22) PCT Filed: Mar. 26, 2015
(86) PCT No.: PCT/IL2015/050320

§ 371 Date: Aug. 29, 2016

Related U.S. Application Data
(60) Provisional application No. 61/970,965, filed on Mar. 27, 2014.

(51) Int. Cl. C09D 101/02; B01J 20/28; A01C 1/06; B01J 20/24

(52) U.S. Cl. CPC C09D 101/02; B01J 20/24; B01J 20/28023; A01C 1/06

(57) ABSTRACT

Provided are novel uses of cellulose-based nanomaterials in the manufacture of absorbent materials or encapsulation materials for absorbing, carrying or encapsulating a variety of agents.

### TECHNOLOGICAL FIELD

The invention generally relates to cellulose nano-materials as carrier materials for the agro and medicinal fields.

### BACKGROUND

Materials capable of absorbing and retaining aqueous media as well as organic or inorganic agents, in liquid, solid or solution form, are the subject of substantial commercial interest. Such materials may be employed in a great variety of applications, e.g., in fields such as agriculture, food, chemicals, cosmetics and medicaments.

U.S. Pat. No. 4,985,467 discloses a hydrophilic polyurethane article which is the skeletal network of a cellular polyurethane foam subjected to reticulation wherein the polyurethane contains up to 100 parts of superabsorbent material per hundred parts of polyol used in preparing the polyurethane.

U.S. Pat. No. 5,451,452 discloses absorbent foams comprising a superabsorbent polymer and cross linking agent.

Nanocrystalline cellulose (NCC) is a fibrous material produced from cellulose, typically having an elongated shape.

### REFERENCES

[1] U.S. Pat. No. 4,985,467

[2] U.S. Pat. No. 5,451,452

### SUMMARY OF THE INVENTION

The present invention provides a novel use of cellulose-based nanomaterials as absorbent materials and as carriers or encapsulation materials for agents for use in fields such as agriculture, food, chemicals, cosmetics and medicaments. The high performance of the cellulose-based materials in any one of the applications of the invention may be characterized by any one or more of high water retention, high liquid re-absorbance, lack of toxicity, root permeability and penetration, protection against pests (microorganisms, insects and parasitic plants), while permitting uninterrupted release of materials therefrom and long shelf-life.

As these materials are environmentally safe and pose no toxicity to the environment or an end-user, their novel uses according to the invention need not be limited to quantity or form.

Thus, the materials of the invention may be manipulated into a variety of forms, including a gel, a membrane, a tablet, a packed material of various weights and degrees of wetness, as ready-for-use forms, wet forms, dry forms, fully absorbed forms, dry loaded forms (wherein the material is loaded with one or more active and/or inert materials), for encapsulating a material, for as-is use or for use in combination with other similarly safe materials, e.g., composite polymers.

The invention thus provides in a first of its aspects an absorbent material for holding at least one agent in a liquid or solid form, said absorbent material being selected from cellulose whiskers (CW, also known as nanocrystalline cellulose, NCC), microfibrillar cellulose (MFC) and bacterial cellulose (BC). In some embodiments, the material is NCC or MFC.

The invention further provides a cellulose-based material for use as a carrier article or a carrier material of at least one liquid or solid agent, the cellulose-based material being selected from NCC, MFC and BC, wherein said liquid or solid agent is not a polymer. In some embodiments, the material is NCC or MFC.

In some embodiments, said liquid or solid agent contained in said article may be released from said carrier over time or upon exposure to one or more external conditions such as radiation, heat, humidity, and any combination thereof.

The invention further contemplates a particulate material comprising at least one agent selected from agents used in agriculture, medicine or cosmetics, the particulate material being selected from NCC, MFC and BC. In some embodiments, the material is NCC or MFC.

Further provided are composites of a cellulose-based material and at least one agent incorporated in said cellulose-based material, to permit release of said at least one agent from said cellulose-based material over time. The release may have a slow release or controlled release profile. The release may be spontaneous or may be initiated by exposure to one or more external conditions such as radiation, heat, humidity, and any combination thereof.

In some embodiments, the cellulose-based material is a cellulose nano-material (NCC).

As known in the art, NCC are elongated crystalline rod-like nanoparticles and the MFC are elongated strings consisting of alternating crystalline and amorphous segments. As used herein, MFC also encompasses nanofibrillated cellulose (NFC). Bacterial cellulose (BC) is a nanostructured extracellular product obtained from certain cellulose producing bacteria such as Gluconobacter Xilinus The cellulose fibrils, being generally of higher crystallinity and purity than those obtained from plant sources, are inherently of nano-sized dimensions.

In some embodiments, the cellulose nano-material is characterized by having at least 50% crystallinity. In further embodiments, the cellulose nano-material is monocrystalline.

In some embodiments, the cellulose nanomaterial is NCC. The NCC may be purchased or prepared according to any one known method, including methods disclosed in WO2012/032514 and WO2012/014213, or any corresponding US application or US patent, each being incorporated herein by reference.

The cellulose material, e.g., NCC, may be in any form suitable for use. In some embodiments, the material is in a form selected from an emulsion, a dry or liquid form, a granulated form, a particulate form (of any particle size, nanoparticles or microparticles or macrosized particles), a powder, and others. In some embodiments, the absorbent material is in the form of a dry granulated powder.

In other embodiments, the material is in the form of a porous material. In other embodiments, the material is in the form of an aerogel.

In some embodiments, where the material is or comprises NCC, the material may be reduced in size in order to increase surface area and provide particulate materials which are capable of absorbing or holding said solid or liquid agents in a desired quantities. Further, the reduction in size of the material may be required for controlling the delivery of the materials and/or for modulating agent release therefrom.

The material is capable of absorbing and/or retaining a liquid, particularly an aqueous medium, e.g., water, but also organic materials, e.g., solvents. The absorbent material is capable of absorbing and retaining liquid up to 10, 20, 30, 40, 50, 60, 70, 80, 90, 100, 200, 300, 400 or 500 times its weight.

Thus, the material may be employed in any of a variety of applications, including: in disposable absorbent products such as disposable personal care products, e.g., diapers, incontinence products, bed pads, sanitary napkins, panty liners, tampons, wound dressings, and delivery systems, wipes, food packaging and the like. The absorbent material may also be employed as laminates, as filtration systems, fire-retardant materials, fragrance materials, matrices for spill control, surgical pads, potting materials, water-retaining materials, water-replenishment materials, wound dressings, and others.

In some embodiments, the material is adapted for use in agriculture. In some embodiments, the material is used neat as a growth medium or used in combination with soil or earth or a different growth medium, e.g., perlite, to provide a growth medium of a variety of forms for a variety of agricultural and non-agricultural purposes. For the execution of some applications, the material may be placed in the vicinity of plant roots to provide for sufficient supply of liquid, e.g., water, nutrients or agents.

In other embodiments, the material is used in reducing an amount of irrigation, retention of melt water and dew deposits, composting additives, protection of forests against fungal/insect infestations, delayed release of active components to plants, and others.

In other embodiments, the material is incorporated with a fertilizer with or without additional microelements.

In some embodiments, the fertilizer is a short or long-term fertilizer. In some embodiments, the fertilizer may be selected from NPK fertilizers, i.e., fertilizers that include one of more of the macronutrients (nitrogen, phosphorus and potassium).

In some embodiments, the fertilizer is selected amongst macro and/or micro nutrients that are taken up and utilized by a growing crop.

In some embodiments, the fertilizer is selected from a nutrient-containing material that is employed to deliver fertilizer nutrients to a crop.

In some embodiments, the fertilizer is selected to release one or more of nitrogen, phosphorus, potassium, calcium, magnesium, sulfur, boron, chlorine, copper, iron, manganese, molybdenum and zinc.

In some embodiments, the fertilizer is a macronutrient, or micronutrient selected from ammonium sulfate, urea, potash, ammonium, phosphate, potassium nitrate, calcium nitrate, sodium nitrate, potassium sulfate, monoammonium phosphate (MAP), diammonium phosphate (DAP), triple super phosphate, and NPK fertilizers. In some embodiments, the fertilizer/macronutrient/micronutrient may include iron, copper, zinc, boron, manganese, and their oxy-sulfate, sulfate, and oxide forms. In some embodiments, the fertilizer/macronutrient/micronutrient may include nitrogen, phosphorus, potassium, calcium, and sulfur.

In other embodiments, the material is incorporated with an active substance. The active substance which is incorporated in the material may be any one or more agents selected from insect growth regulators (IGR), short or long-term fertilizers, minerals, hormones, micro-elements, macro-elements, herbicides, insecticides, acaracides, fungicides, nematicides, ectoparasiticides, coloring agents, odor agents, flavoring agents, antioxidants, stabilizers, detergent, and others depending on the targeted use.

In some embodiments, the material may comprise a pesticide selected from carbamates, ureas, triazines, triazoles, uracils, organophosphates, morpholines, dinitroanilines, acylalaninies, pyrethroids and organochlorines.

The pesticides may be selected from synthetic, naturally obtained or modified agents such as carbofuran, azinphos-methyl, sulfentrazone, carfentrazone-ethyl, cypermethrin, cyromazine, beta-cyfluthrin, endosulfan, phosmet, chlorobromuron, chloroxuron, chlorotoluron, fluometuron, metobromuron, thiazafluoron, teflubenzuron, hexaflumuron, diflubenzuron, flufenoxuron, lufenuron, chlorfluazuron, novaluron. dimethachlor, metolachlor, pretilachlor, 2-chloro-n-(1-methyl-2-methoxyethyl)-acet-2,6-xylidide, alachlor, butachlor, propachlor, dimethenamid, bifenox, 4-(4-pentyn-1-yloxy)diphenylether, acifluorfen, oxyfluorfen, fluoroglycofen-ethyl, fomesafen, cis,trans-(+)-2-ethyl-5-(4-phenoxyphenoxymethyl)-1,3-dioxolane, fluazifop-butyl, haloxyfop-methyl, haloxyfop-(2-ethoxyethyl), fluorotopic, fenoxapropethyl, quizalofopethyl, propaquizafop, diclofop-methyl, butralin, ethalfluralin, fluchloralin, isopropalin, pendimethalin, profluralin, trifluralin. aclalanines furalaxyl, metalaxyl, benzoylprop ethyl, flamprop methyl, difenoconazole, etaconazol, propiconazole, 1,2-(2,4-dichlorophenyl)-pent-1-yl-1h-1 ,2,4-triazole, triadimefon, dioxacarb, furathiocarb, aldicarb, benomyl, secbutylphenylmethylcarbamate, etiofencarb, fenoxycarb, isoprocarb, propoxur, carbetamid, butylate, di-allat, eptc, molinate, thiobencarb, tri-allate, vemolate, piperophos, anilofos, butamifos, azamethiphos, chlorfenvinphos, dichlorvos, diazinon, methidathion, azinphos ethyl, azinphos methyl, chlorpyrifos, chlorthiofos, crotoxyphos, cyanophos, demeton, dialifos, dimethoate, disulfoton, etrimfos, famphur, flusulfothion, fluthion, fonofos, formothion, heptenophos, isofenphos, isoxathion, malathion, mephospholan, mevinphos, naled, oxydemeton methyl, oxydeprofos, parathion, phoxim, pyrimiphos methyl, profenofos, propaphos, propetamphos, prothiophos, quinalphos, sulprofos, phemephos, terbufos, triazophos, trichloronate, fenamipos, isazophos, s-benzyl-o,odiisopropylphosphorothioate, edinphos and pyrazophos.

In some embodiments, the material to be incorporated is selected amongst essential oils such as pyrethrum, glycerol-derived lipids or glycerol fatty acid derivatives, sesame oil, cinnamon oil, cedar oil, clove oil, geranium oil, lemongrass oil, angelica oil, mint oil, turmeric oil, wintergreen oil, rosemary oil, anise oil, cardamom oil, caraway oil, chamomile oil, coriander oil, cumin oil, dill oil, mint oil, parsley oil, basil oil, bay oil, camphor oil, citronella oil, eucalyptus oil, fennel oil, ginger oil, copaiba balsam oil, perilla oil, cedarwood oil, jasmine oil, palmarosa sofia oil, western mint oil, star anis oil, tuberose oil, neroli oil, tolu balsam oil, patchouli oil, palmarosa oil, Hiba oil, sandalwood oil, grapefruit oil, lemon oil, mandarin oil, orange oil, oregano oil, lavender oil, Lindera oil, pine needle oil, pepper oil, rose oil, sweet orange oil, tangerine oil, tea tree oil, thyme oil, thymol oil, garlic oil, peppermint oil, onion oil, linaloe oil, Japanese mint oil and spearmint oil.

In some embodiments, the materials of the invention may comprise adjuvants, adhesives, antioxidants, water-resistant agents and surfactants. Such additives may be selected from gamma-linolenic acids, citrus oils, nutritional supplements such as Vitamin A, Vitamin E, Vitamin C, and Vitamin D, tocopherols, tocotrienols, phytosterols, Vitamin K, beta-carotene, marine oils, omega-3 fatty acids, CoQ10, lipid soluble derivatives of polar antioxidants, such as ascobyl fatty acid esters, plant extracts such as rosemary, sage and oregano oils, algal extracts, and synthetic antioxidants such as BHT, TBHQ, ethoxyquin, alkyl gallates and hydroquinones or natural antioxidants.

The products of the invention for agricultural uses may be applied onto the ground or a plant surface by any method known in the field, for example by spraying. Spraying of a liquid formulation comprising encapsulated materials according to the invention, onto a target surface of a plant or the ground, may be at any desired concentration. The amount of material applied may also depend on the size of the cellulose nanocapsules comprising the material, the solid or liquid vehicle used for application, the number of applications onto the same site, the method of application and a variety of other parameters known to a person of skill in the art.

In some embodiments, the cellulose-based material of the invention may be utilized as a protective coating or protective film for the safe storage and use of explants such as shoot tips, axillary buds, somatic embryos, seeds and others that can be developed into a plant. The cellulose-based material protects the explants from mechanical damage during handling, storage without preventing or deteriorating the explant's ability to germinate.

The ability of the cellulose-based coating to further hold, together with the explants, one or more additive, such as a stabilizer, a fertilizer, a nutrient, a herbicide, a pesticide or any other additive as disclosed herein, and its ability to release a material from within the coating, allows for effective germination and conversion to occur.

The explants coated material according to the invention, finds its advantages not only in the increased stabilities during handling, long term storage and transportation, but also in the explants viability and the ability to plant the coated explants without needing to expose the explants prior to planting.

In some embodiments, the explant is a plant seed. In some embodiments, the plant seed is encapsulated, coated or otherwise contained within a cellulose material, as defined, optionally along with at least one nutrient and optionally at least one pesticide. In some embodiments, the cellulose material is NCC.

The plant seeds are, in some embodiments, seeds of various cultivated plants, such as:
cereals as wheat, rye, barley, triticale, oats or rice;
fruits as pomes, apples, pears, plums, peaches, almonds, cherries, strawberries, raspberries, blackberries or gooseberries;
citrus fruit such as oranges, lemons, grapefruits or mandarins;
leguminous plants such as lentils, peas, alfalfa or soybeans;
oil plants such as rape, oil seed rape/canola, mustard, olives, sunflowers, coconut, cocoa beans, castor oil plants, oil palms, ground nuts or soybeans;
cucurbits such as squashes, cucumber or melons;
fiber plants such as cotton, flax, hemp or jute;
vegetables such as spinach, lettuce, asparagus, cabbages, carrots, onions, tomatoes, potatoes, cucurbits or paprika;
lauraceous plants such as avocados, cinnamon or camphor;
food plants or fruits such as corn, soybean, rape, sugar cane, oil palm, tobacco, nuts, coffee, tea, bananas, vines;
horticulture seeds such as flowers, shrubs, broad-leaved trees or evergreens; and others.

The seeds or any of the other explants disclosed and defined herein, may be coated or encapsulated within a coating or a film of a cellulose nanomaterial by employing the methods comprising the steps of suspending or depositing on the surface of the explants a solution/dispersion or emulsion of the cellulose nanomaterial in a solvent, as exemplified herein.

In some embodiments, the at least one cellulose nanomaterial, e.g., NCC, may be used as an encapsulant of said at least one agent.

The form of encapsulation may vary based inter alia on the end intended application, method and conditions of application, type of agent to be encapsulated, quantity of said agent, etc. In some embodiments, the at least one agent is granulated with said cellulose nanomaterial, such that the whole surface of cellulose nanomaterial particle is covered with a coating of the agent. Alternatively, the encapsulation of the agent may be by forming a shell of the cellulose nanomaterial around particles of said agent. The resulting particles may have core-shell structures.

Generally, the methods for making such particulate materials comprise the steps of dissolving/dispersing/suspending the agent in an appropriate solvent to form a solution/dispersion or emulsion, mixing thereto an effective amount of the cellulose material, introduce suitable conditions which would allow particle formation, e.g., drying the mixed solution to form a powder comprising encapsulated agents. In alternative methods, the solid agents may be formed into granulated or particulate materials and may thereafter treated with a solution of the cellulose nanomaterial to form on the surface of the granulated or particulate agent materials a shell of a variety of thickness and compositions.

The particulate cellulose nanomaterial/agent may be in the form of a material sphere, material particle, core-shell, generally defines as nanomaterial or micromaterail, wherein the agent may be encapsulated in the cellulose nanomaterial, in an empty core of the cellulose nanomaterial, mixed in the cellulose nanomaterial and capsulated thereafter, etc.

The material of the invention may be similarly suitable for use in hygiene or sanitaria products.

### BRIEF DESCRIPTION OF THE DRAWINGS

FIG. 1 depicts percent germination of NCC-coated seeds.

FIG. 2 demonstrates development of a first set of leaves in NCC-coated seeds.

### EXPERIMENTAL SECTION

Production of NCC-Coated Plant Seeds

Explants, such as plant seeds are dipped in slurry comprising NCC and optionally at least one fertilizer and pesticide. The seeds are subsequently allowed to dry to produce beads of the NCC material. Each bead may contain one or more seeds.

Alternatively, seeds may be coated with the slurry by any other coating method available to produce beads of NCC, each containing one or more plant seeds.

Seed Germination from NCC Coated Seeds

Mung bean seeds were dipped into an NCC suspension (2%) or into water (as a control). The seeds were subsequently dried and sown on a wet perlite bedding, inside a germination tray—5 repeats of two seeds for each watering treatment, to a total of 10 seeds.

After one day, the seeds were watered with a certain volume of water per day, as described in the table below. Germination of the seeds was monitored for 7 days.

| Uncoated seeds | NCC coated seeds | |
|---|---|---|
| 0 | 0 | Water volume (ml) |
| 1 | 1 | |
| 2 | 2 | |
| 4 | 4 | |

Results:

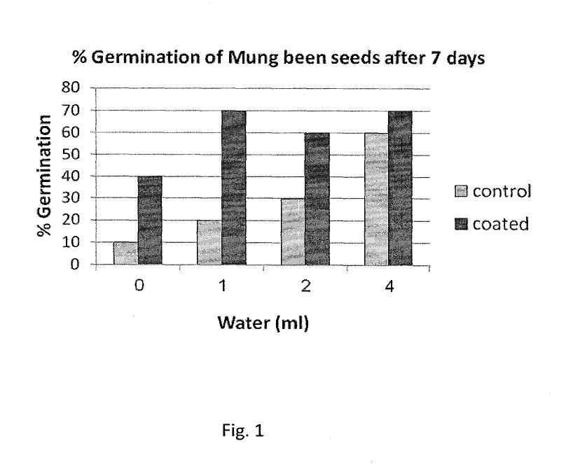

The percent germination of NCC-coated seeds was significantly higher (FIG. 1). Seedlings height from the 4 ml water treatment was measured; the average height of the coated seedlings was 3.14 cm compared to 2.7 cm of the control seedlings, showing the advantage of the treatment even in non-drought conditions.

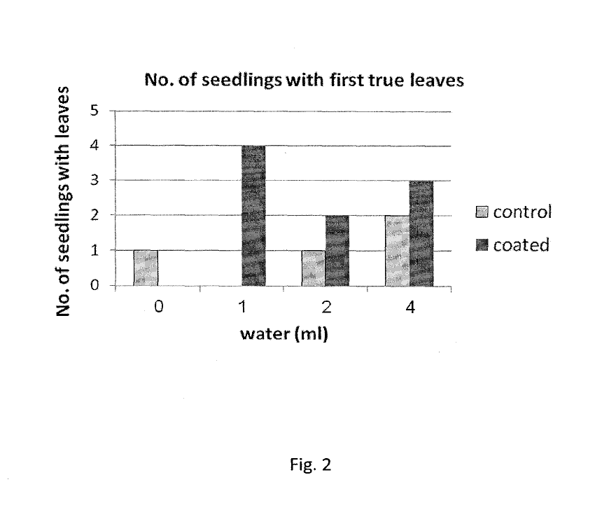

In addition to increased height of seedlings germinating from NCC-coated seeds, the seedlings were faster to develop a first set of leaves, showing a clear developmental advantage over the control (FIG. 2).

1.-35. (canceled)

36. A cellulose-based nanomaterial in a form selected from the group consisting of an absorbent material, a carrier material and an encapsulation material for absorbing, carrying or encapsulating at least one agent selected from the group consisting of agricultural materials, food additives, food coloring agents, flavors, chemical agents, cosmetics and pharmaceutical agents, wherein said at least one agent is not a polymer.

37. The material according to claim 36, wherein the cellulose-based nanomaterial is in a form selected from the group consisting of a gel, a tablet, a packed material, a ready-for-use form, a wet form, a dry form, a fully absorbed form, a dry loaded form, and an encapsulating material.

38. The material according to claim 36, wherein said cellulose-based material is selected from the group consisting of nanocrystalline cellulose (NCC), microfibrillar cellulose (MFC) and bacterial cellulose (BC), wherein said at least one agent is not a polymer.

39. The material according to claim 36, wherein said at least one agent being in a liquid or solid form, or is a plant material.

40. The material according to claim 39, wherein said at least one liquid or solid agent is released from said absorbent material or carrier material or encapsulation material over time or upon exposure to one or more conditions selected from heat, light and humidity.

41. The material according to claim 38, wherein said cellulose-based nonmaterial is NCC.

42. The material according to claim 37, wherein said cellulose-based nanomaterial being in a form selected from the group consisting of disposable personal care products, diapers, incontinence products, bed pads, sanitary napkins, panty liners, tampons, wound dressings, delivery systems, wipes, food packaging, laminates, filtration systems, fire-retardant materials, fragrance materials, matrices for spill control, surgical pads, potting materials, water-retaining materials, water-replenishment materials and wound dressings.

43. The material according to claim 36, wherein the cellulose-based nanomaterial is in neat form as a growth medium or in combination with soil or earth is incorporated with a fertilizer with or without additional microelements.

44. The material according to claim 36, for forming a protective coating or protective film on an explant.

45. The material according to claim 44, wherein said explant is selected from shoot tips, axillary buds, somatic embryos, seeds and a plant section capable of developing into a plant.

46. The material according to claim 45, for protecting the explant from mechanical damage during handling, storage without preventing or deteriorating the explant's ability to germinate.

47. The material according to claim 44, wherein the explant is a plant seed.

48. The material according to claim 47, wherein the plant seed is encapsulated, coated or contained within a cellulose material, optionally together with at least one nutrient and/or at least one pesticide.

49. The material according to claim 44, being NCC.

50. An explant coated with at least one cellulose-based material.

51. The explant according to claim 50, wherein said cellulose-based material is NCC.

52. A plant seed coated with at least one cellulose-based material.

53. The plant seed according to claim 52, wherein the cellulose-based material is NCC.

54. A growth medium comprising at least one cellulose-based material selected from nanocrystalline cellulose (NCC), microfibrillar cellulose (MFC) and bacterial cellulose (BC).

55. A cellulose-based material comprising at least one agent selected from the group consisting of agricultural materials, food additives, food coloring agents, flavors, chemical agents, cosmetics and pharmaceutical agents, wherein said at least one agent is not a polymer.
